(19) United States
(12) Patent Application Publication
(10) Pub. No.: US 2009/0298993 A1
(43) Pub. Date: Dec. 3, 2009

(54) PHENOLIC RESIN COMPOSITIONS CONTAINING WELL DISPERSED WHOLLY INORGANIC EXPANSIBLE CLAY PARTICLES

(76) Inventors: Leonard E. Kosinski, Woodstock, GA (US); Richard Soelch, Essex Junction, VT (US)

Correspondence Address: Andrew Auerbach, Patent Agent, 23 Orchard Lane, Livingston, NJ, 07039, US

(21) Appl. No.: 12/127,260

(22) Filed: May 27, 2008

(51) Int. Cl. C08K 3/34

(52) U.S. Cl. 524/446; 524/445; 524/447

(57) ABSTRACT

This invention relates to phenolic resin compositions containing less than 5 percent by weight of wholly inorganic expansible clay particles well dispersed therein, methods for making the same, and articles incorporating the same. The wholly inorganic clay particles are added to a phenolic resin liquid, where the clay form as added can range between a powder and a dilute aqueous dispersion. The resulting phenolic resin and clay compositions have improved physical properties and increased adhesion to other materials.

### CROSS-REFERENCE TO RELATED APPLICATIONS

Not Applicable

### CLAIM TO PRIORITY

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

(1) Field of the Invention

This invention relates to phenolic resin compositions containing less than 5 percent by weight of wholly inorganic expansible clay particles well dispersed therein, methods for making the same, and articles incorporating the same. The wholly inorganic clay particles are added to a phenolic resin liquid, where the clay form as added can range between a powder and a dilute aqueous dispersion. The resulting phenolic resin and clay compositions have improved physical properties and increased adhesion to other materials.

(2) Description of the Related Art

Phenolic resins are condensation products of an aldehyde and a phenolic compound, most often, formaldehyde and phenol. Other non-limiting examples of aldehydes sometimes used are acetaldehyde and furfuraldehyde. Other non-limiting examples of phenolic compounds sometimes used are dihydroxy benzenes or alkyl-substituted phenols, such as cresols, xylenols, p-tert-butyphenol, p-phenylphenol, and nonylphenol.

There are two types of phenolic resins, resoles and novolaks. Resoles are produced in a one-step process either as aqueous syrup (liquid resole) or as a varnish (solid resole dissolved in an alcohol or other organic solvent). Novolaks are produced in a two-step process to form solid phenolic resins, for example, molding powders.

Resole resins are typically produced in a batch reactor using a mole ratio of 1 to 3 aldehyde to phenolic compound, respectively, along with a basic catalyst. The molten phenolic compound (which can contain some water) and basic catalyst are first charged into the reactor. Next, the aldehyde is added as a solution (e.g., if formaldehyde either a 37 percent by weight or 50 percent by weight aqueous solution) to the reactor at a rate to maintain a desired temperature. The reactor is then controlled so as to conduct the condensation polymerization, and when the desired end-point is reached, the reaction mixture is often neutralized with an acid.

The phenolic resole resin process can produce either liquid or solid resoles. Liquid resoles are produced as aqueous syrups with a targeted degree of polymerization, degree of substitution, pH, and water content. These aqueous syrup phenolic resoles are discharged from the reactor, typically as 40 percent by weight to 90 percent by weight solid content, and stored, usually in a refrigerator, for subsequent use. The phenolic resole process can include removal of all or nearly all the water from the reactor. This liquid phenolic resole resin when discharged from the reactor solidifies upon cooling. The solid phenolic resole resin is dissolved (in alcohol, organic solvents, or combinations thereof) to form the phenolic resole varnish solution and stored for subsequent use. In either liquid or solid resoles, additives and modifiers may be introduced during different steps of the process.

Novolak resins are produced using a mole ratio of aldehyde compound to phenolic compound less than 1, normally between 0.70 and 0.85, along with an acid catalyst. The phenolic compound is charged to the reactor and then the acid catalyst added. The aqueous aldehyde solution is added to the reactor with stirring at a rate to maintain gentle boiling of the mixture. The temperature of the mixture is maintained until the reaction has exhausted the supply of the aldehyde compound. Water and unreacted phenolic compound are removed from the reaction mixture by applying external heat at atmospheric pressure. The reaction mixture is heated to a higher temperature, and by using a vacuum and injecting live steam the residual volatiles are removed from the resin. When the desired melting point is reached, the novolak resin is fed to a heated vessel. The resin is then typically flaked onto a continuous cooling belt. The flake can be fed to a grinder to form a powdered resin.

To make useful articles from phenolic resins, the phenolic resins are usually cured, that is, subjected to conditions to polymerize further and to cross-link the resin. A phenolic resole resin can be made to react without addition of a curing agent, and because of this one component characteristic are referred to as single-stage. A novolak phenolic resin requires incorporation of a curing agent (and optionally a curing catalyst), and are referred to as two-stage. Novolak curing agents are typically multifunctional amines, such as hexamethylenetetramine.

The primary use for phenolic resins can be said to be as a binding agent for a wide variety of organic materials, inorganic materials and combinations thereof. The uncured phenolic resin or a solution of the uncured phenolic resin (in either case along with curative agent and catalyst as needed) is contacted with the substrate(s) to be bonded by any number of methods known to those skilled in the art to accomplish, mixing, coating, and the like. Subsequently, the phenolic resin in contact with the other substrate(s) is usually subjected to conditions so as to cure (i.e., polymerize and cross-link) the phenolic resin.

The materials bonded by the phenolic resin can be of various shapes and sizes. Non-limiting examples of the materials bonded by phenolic resins are particles, fibers, regular or irregular shapes, surfaces, and combinations thereof. The materials bonded by the phenolic resin can function as fillers or reinforcements such as cotton, wood flour, glass flake, glass beads, chopped glass fiber, chopped carbon fiber, chopped para-aramid or meta-aramid fiber, clays, calcium carbonate, and other minerals. The materials being bonded by the phenolic resin may also have a functional purpose, for example, abrasive grits such as aluminum oxide, zirconium oxide, garnet, diamonds, etc. used to make cutting wheels. A phenolic resin can be used to bond abrasive particles into defined assemblies prior to forming a finished abrasive product. Materials such as paper, polymer sheet, woven cloths, and non-woven cloths can be coated with a phenolic resin, an abrasive grit applied on top of the phenolic resin coating, and a second phenolic resin coating applied on top of the abrasive grit to produce a coated abrasive product. Filament winding is used for glass fiber, carbon fiber, nylon fiber, meta-aramid and para-aramid fiber, metal fibers, etc. and bonded using phenolic resin. Irregular fiber assemblies can also be bonded using phenolic resins such as rockwool slabs used as insulation and plant growth medium. Phenolic resins are used to bond layered structures such as wood laminates (e.g., plywood) and woven cloths of fibers or filaments. The materials being bonded by phenolic resins can be of irregular shapes and sizes such as the wood forms used to make particle board and oriented strand board. A phenolic resin is used to bond to a silicon wafer surface to function as a photomask. Phenolic resins are used to produce friction materials such as brake linings, disc brake pads, drum brake blocks, transmission components, etc. Phenolic resins are also used in automotive applications such as disc brake pistons, pulleys, water pump housings, solenoids, ashtrays, motor housings and the like. Typical electrical applications include commutators, solenoid caps, alternator slip rings, motor and gear housings. Appliance applications using phenolic resins are knobs, handles and heated toaster components, broilers, steam irons, thermostats and timer cases. Phenolic resins are also used in prepeg systems for fireproof aircraft panels. Combinations of materials to be bonded by the phenolic resin occur, such as the phenolic resin being filled or reinforced with a particulate material being used as the binder in a laminated structure (e.g., plywood). These phenolic resins as binders with the materials being bonded can contain in addition to a curative agent and curative catalyst (as needed), pigments, colorants, impact modifiers, stabilizers, etc. The phenolic resin with the material(s) being bonded is usually cured to affect the bonding.

The wholly inorganic expansible clays of the present invention are layered silicates. These clays can be mined from natural sources or can be synthetic in origin. These clays exhibit the property of being able to incorporate water into the interlayer space thereby increasing the distance between the layers, i.e. expanding. The expansible clay particles have negatively charged surfaces which are neutralized by cations being adsorbed on the surfaces of adjacent particles. The interlayer cation type affects the expansibility and absorptive properties of these clays. Typical inorganic interlayer cations include ammonium, barium, calcium, lithium, magnesium, potassium, and sodium. Often in commercial practice the inorganic interlayer cations are exchanged, i.e. replaced, with organic onium ions such as quarternary ammonium or quarternary phosphonium ions having an organic aliphatic tail which is to be used as an intercalant to facilitate disruption of the silicate structure as a precursor to exfoliation. This invention does not use organic intercalants.

U.S. Pat. No. 3,637,547 discloses and claims a phenol-aldehyde adhesive for wood laminates containing from 5 to 50 weight percent of a colloidal attapulgite or a colloidal sepiolite clay. When the adhesive composition does not contain other fillers or extenders, the preferred amount of clay is increased to 10 to 25 percent. Both attapulgite and sepiolite are acicular (i.e. needle-like) clays with the acicular shape being taught as the origin of the unique physical properties observed. Both attapulgite and sepiolite are not expansible clays.

U.S. Pat. No. 4,441,954 discloses a phenol-aldehyde based adhesive for wood containing 5-50% bentonite clay with the preferred bentonite range of 20-35% also being the claimed composition range. This patent mentions the swellable property of bentonite clay, and the claimed compositions are based on an aqueous phenolic resole.

U.S. Pat. No. 4,233,361 claims composite foam panels made from thermoplastic expandable foam particles encapsulated in a resole resin foam. The claimed resole resin foam also contains an expanded glass in particulate form, such as perlite. The specification states the resole foam with expanded glass can also contain a wide variety of additional fillers. The named fillers include the clays bentonite, kaolin, attapulgus, expanded vermiculite, and non-expanded vermiculite. The specification describes resole compositions containing more than 10 weight percent filler content, and illustrated an example using about 12.7% kaolin clay (a non-expansible clay).

U.S. Pat. No. 5,309,690 discloses and claims a composite panel made from a natural fiber material treated with a thermosetting resin to create cellular core spaces where the cellular core spaces are filled with an inorganic filler. The thermosetting resin can be a resole and the inorganic filler can be an expansible clay; however, the thermosetting resin and the inorganic filler are never mixed together.

U.S. Pat. No. 6,518,324 discloses and claims polymer foams containing up to 10 percent by weight nanoclay. The polymer component of the foam can be a thermoplastic or a thermoset, with the thermoset types named including phenolic resins. The nanoclays named include montmorillonite as a preferred clay, and names Cloisite 10A as one such material. Cloisite 10A is a montmorillonite where the inorganic interlayer cations are exchanged with an organic quartemary ammonium ion. The nanoclay is said to provide nucleation in the foaming process and to provide a gas barrier in the resulting foam. The amount of clay is said to generally range from about 0.01 parts to about 10 parts nanoclay to 100 parts by weight total polymer resin. The exemplified polyurethane foam used 0.073 weight percent Cloisite 10A (about 0.047% clay).

U.S. Pat. No. 5,801,216 discloses and claims flexible epoxy resins containing expansible clays. The inorganic interlayer cations of the expansible clay needs to be exchanged with organic ammonium ions to achieve tensile strength and/or solvent resistance benefits for the cured epoxy resin.

U.S. Pat. No. 6,203,901 discloses and claims polyurethane urea thermoset fibers and films containing expansible clays. The expansible clays are introduced to the polymer using an aprotic polar solvent. Benefits provided by the expansible clays included reduced tack, i.e. reduced adhesion, of the fibers and films.

U.S. Pat. No. 6,841,607 discloses and claims thermosetting resin compositions containing expansible clays where their interlayer inorganic cations have been exchanged with organometallic compounds. The thermoset resin types named were phenolic resins, unsaturated polyester resins, vinyl ester resins, polyurethane forming resins, and epoxy resins; with unsaturated polyester resins being most preferred and the one resin exemplified.

U.S. Pat. No. 6,887,931 discloses and claims thermosetting resin compositions containing expansible clays where their interlayer inorganic cations have been exchanged with an organic quarternary ammonium compound. The clay interlayer cation exchange is done in situ in a non-aqueous environment.

U.S. Pat. No. 6,838,509 discloses and claims a phenolic resin containing a particulate filler and an organized layered clay. The organized layered clay of this invention is an expansible clay where its interlayer cations are organic onium ions.

### BRIEF SUMMARY OF THE INVENTION

The present invention is clearly different than the prior art such as those references previously discussed herein. The references with wholly inorganic clays (non-expansible and expansible) that disclosed clay contents of 5 percent and more, missed the surprising benefits at clay contents of less than 5 percent of the present invention. Another reference disclosed wholly inorganic expansible clays reduced tack (i.e., adhesion), making the increased adhesion of the present invention unexpected. Most prior art efforts involve using organoclays where the clay inorganic interlayer cations are exchanged with organic cations. The organoclays are taught to be necessary to achieve good dispersion and improved physical properties which are taught not to be obtainable using wholly inorganic expansible clays. Pre-dispersion of these organoclays is done in aprotic solvents before mixing with monomers or polymers. The present invention is unique in that it uses wholly inorganic expansible clays, i.e., having inorganic cations in the clay interlayers, and employs water (protic solvent) to expand the clay. Additionally surprising in light of the prior art teachings that organoclays give superior performance relative to wholly inorganic clays are the antithetical results of the present invention.

The present invention provides phenolic resin compositions containing less than 5 percent by weight of wholly inorganic expansible clay particles well dispersed therein. By well dispersed, we mean the clay particles are impossible or nearly impossible to see with the unaided human eye in the uncured or cured phenolic resin compositions of the present invention. No organic intercalants have been used in this invention.

The present invention also provides methods for making the phenolic resin compositions containing less than 5 percent by weight of wholly inorganic expansible clay particles well dispersed therein.

The present invention also includes applications for the improved properties of the phenolic resin compositions containing less than 5 percent by weight of wholly inorganic expansible clay particles well dispersed therein.

### DETAILED DESCRIPTION OF THE INVENTION

Phenolic resins are condensation products of an aldehyde and a phenolic compound, most often, formaldehyde and phenol. Other non-limiting examples of aldehydes sometimes used are acetaldehyde and furfuraldehyde. Other non-limiting examples of phenolic compounds sometimes used are dihydroxy benzenes or alkyl-substituted phenols, such as cresols, xylenols, p-tert-butyphenol, p-phenylphenol, and nonylphenol.

There are two types of phenolic resins, resoles and novolaks. Resoles are produced in a one-step process either as aqueous syrup (liquid resole) or as a varnish (solid resole dissolved in an alcohol or other organic solvent). Novolaks are produced in a two-step process to form solid phenolic resins, for example, molding powders.

Resole resins are typically produced in a batch reactor using a mole ratio of 1 to 3 aldehyde to phenolic compound, respectively, along with a basic catalyst. The molten phenolic compound (which can contain some water) and basic catalyst are first charged into the reactor. Next, the aldehyde is added as a solution (e.g., if formaldehyde either a 37 percent by weight or 50 percent by weight aqueous solution) to the reactor at a rate to maintain a desired temperature. The reactor is then controlled so as to conduct the condensation polymerization, and when the desired end-point is reached, the reaction mixture is often neutralized with an acid.

The phenolic resole resin process can produce either liquid or solid resoles. Liquid resoles are produced as aqueous syrups with a targeted degree of polymerization, degree of substitution, pH, and water content. These aqueous syrup phenolic resoles are discharged from the reactor, typically as 40 percent by weight to 90 percent by weight solid content, and stored, usually in a refrigerator, for subsequent use. The phenolic resole process can include removal of all or nearly all the water from the reactor. This liquid phenolic resole resin when discharged from the reactor solidifies upon cooling. The solid phenolic resole resin is dissolved (in alcohol, organic solvents, or combinations thereof) to form the phenolic resole varnish solution and stored for subsequent use. In either liquid or solid resoles, additives and modifiers may be introduced during different steps of the process.

Novolak resins are produced using a mole ratio of aldehyde compound to phenolic compound less than 1, normally between 0.70 and 0.85, along with an acid catalyst. The phenolic compound is charged to the reactor and then the acid catalyst added. The aqueous aldehyde solution is added to the reactor with stirring at a rate to maintain gentle boiling of the mixture. The temperature of the mixture is maintained until the reaction has exhausted the supply of the aldehyde compound. Water and unreacted phenolic compound are removed from the reaction mixture by applying external heat at atmospheric pressure. The reaction mixture is heated to a higher temperature, and by using a vacuum and injecting live steam the residual volatiles are removed from the resin. When the desired melting point is reached, the novolak resin is fed to a heated vessel. The resin is then typically flaked onto a continuous cooling belt. The flake can be fed to a grinder to form a powdered resin.

To make useful articles from phenolic resins, the phenolic resins are usually cured, that is, subjected to conditions to polymerize further and to cross-link the resin. Phenolic resin curing conditions can include, but are not limited to, heating, ultraviolet radiation, microwave radiation, radio frequency radiation, and/or catalyst, and combinations thereof. A phenolic resole resin can be made to react without addition of a curing agent, and because of this one component characteristic are referred to as single-stage. A novolak phenolic resin requires incorporation of a curing agent (and optionally a curing catalyst), and are referred to as two-stage. Novolak curing agents are typically multifunctional amines, such as hexamethylenetetramine.

The wholly inorganic expansible clays of the present invention are layered silicates. These clays can be mined from natural sources or can be synthetic in origin.

Examples of wholly inorganic expansible clays mined from natural sources are montmorillonite, saponite, beidellite, nontronite, hectorite, stevensite, bentonite, or substituents, derivatives, or a mixture of these substances and the like. The mined clay deposits are purified, and can have their interlayer cations exchanged as part of the purification process. The interlayer cation type affects the expansibility and absorptive properties of these clays. Typical inorganic interlayer cations include ammonium, barium, calcium, lithium, magnesium, potassium, and sodium. The wholly inorganic expansible clays of the present invention can have more than one type of inorganic interlayer cation. A preferred interlayer cation is sodium. The preferred purified natural clays of the present invention are montmorillonite and bentonite. Commercially available purified montmorillonite clays are available under the trade name Cloisite (Southern Clay Products, Gonzlaes, Tex.). Commercially available purified bentonite clays are available under the trade name Polargel (American Colloid Company, Arlington Heights, Ill.).

The wholly inorganic expansible clays of the present invention also can be synthetic in origin. Synthetically produced wholly inorganic expansible clays are commercially available under the trade name Laponite (Southern Clay Products, Gonzales, Tex.) and are hydrous sodium lithium magnesium silicates or hydrous sodium lithium magnesium fluoro-silicates and can include a tetra sodium pyrophosphite component. Swelling mica is also a useful expansible clay. Examples of swelling mica are chemically synthesized mica such as SOMASIF (trade name, manufactured by CO-OP Chemical Co., Ltd., Tokyo, Japan) and tetrasilic mica containing a lithium ion or sodium ion in the interlayers, taeniolite or substituents, derivatives or a mixture of these substances. The synthetic materials just described and the like are considered as wholly inorganic expansible clays useful in the present invention.

The present invention provides phenolic resin compositions containing less than 5 percent by weight of wholly inorganic expansible clay particles well dispersed therein. The composition range of this invention is defined by the amounts of cured phenolic resin and wholly inorganic expansible clay. The composition of the present invention can be used with other additives, fillers and reinforcements. Non-limiting examples of additives include pigments, colorants, impact modifiers, stabilizers, nucleants, antistatic agents, plasticizers and the like. Non-limiting examples of fillers and reinforcements include cotton, wood flour, ground nut shells, glass flake, glass beads, glass fibers, carbon black, carbon fibers, carbon nanotubes, para-aramid or meta-aramid fiber, metal fibers, metal flakes, clays, calcium carbonate, and other minerals. The filler may also have a functional purpose, for example, abrasive grit. Non-limiting examples of abrasive grit types include aluminum oxide, zirconium oxide, garnet and diamonds. It is anticipated that the phenolic resin compositions containing less than 5 percent wholly inorganic expansible clay will also be useful with mixtures of the aforementioned additives, fillers and reinforcements.

It is surprising that wholly inorganic clays can be well dispersed in phenolic resins. Typically clay manufacturers add an organic intercalant to the clay to aid in exfoliation, that is, aid dispersion of the clay particles in non-polar mediums, such as polymers. The present invention also provides methods for making the phenolic resin compositions containing less than 5 percent by weight of wholly inorganic expansible clay particles well dispersed therein. The wholly inorganic expansible clays of the present invention can contain from about 2 percent to about 15 percent absorbed water (on a dried clay basis) in their interlayer spaces, and still appear as freely flowing fine powders. The methods to provide wholly inorganic expansible clay particles well dispersed in phenolic resins employ a stage where the uncured phenolic resin components (monomers or partially reacted monomers, catalyst, and the like), the wholly inorganic expansible clay, and water (in an amount over and above the water already present in the clay interlayer spaces) are contacted and mixed. The water acts to expand the clays and thereby aid dispersion. The amount of this added water can range from about 0.5 parts by weight to about 500 parts by weight to 1 part by weight of the wholly inorganic expansible clay. The wholly inorganic expansible clay can be in any form ranging from a freely flowing powder to a dilute aqueous dispersion when added to form the mixture of phenolic resin components, wholly inorganic expansible clay and additional water. The aqueous dispersion form of the wholly inorganic expansible clay is preferred when the objective is to provide maximum adhesion of the compositions of the present invention to a substrate.

Some non-limiting examples of methods to make the compositions of the present invention are described. Phenolic resins are made in a reactor where the phenolic monomer(s), aldehyde monomer(s), and catalyst are charged to the reactor. Usually, these monomers contain some water. The wholly inorganic expansible clays can be charged to the reactor along with the unreacted monomers, or after the monomers have been allowed to react for some time. If the intended phenolic resin discharged from the reactor is to be in solid form after cooling, for example resole resins used to make varnishes or novalak resins, adding clays to the reactor mixture may be the only route to the composition of the present invention. However, if these solid phenolic resins subsequently get dissolved in an aqueous or non-aqueous solvent, clay (or aqueous clay) can be added to the phenolic resin solution to form the compositions of the present invention. Preferred organic solvents for the phenolic resin solution would be those miscible or partially miscible with water such as alcohols, glycols, and the like. Phenolic resole resins are often discharged from the reactor as aqueous syrups where the water content can be from about 5 percent by weight to about 60 percent by weight. The wholly inorganic expansible clays can be added to the reactor to make the resole aqueous syrup products, or alternately, the clay (or aqueous clay) can be added to the resole aqueous syrup product at any time after it is removed from the reactor. It has been noted that when a powder form of the wholly inorganic expansible clay is added to and stirred into an aqueous resole syrup that fine dispersion of the clay particles occurs after about 1-48 hours of sitting. By well dispersed, we mean the clay particles are impossible or nearly impossible to see with the unaided human eye in the uncured or cured phenolic resin compositions of the present invention.

The compositions of the present invention of less than 5 percent by weight of a wholly inorganic expansible clay in a phenolic resin have improved physical properties and increased adhesion to various substrates that will make them particularly useful in a variety of applications. Phenolic molding resins using the composition of the present invention that contain fillers and/or reinforcements, or are applied to various substrates (e.g., a woven glass mat), or containing fillers and/or reinforcements and applied to a substrate. Phenolic resin compositions of the present invention that are used to bond the components of light emitting fixtures (e.g., the metal socket to the glass bulb). Phenolic adhesives of the present invention composition that are used to bond wood laminates or wood particles (e.g., plywood or particle board). Phenolic compositions of the present invention that are used to make friction transmission articles (e.g., brake band liners, brake shoes, lined clutch shoes, dry friction disks, wet friction plates, and the like). Phenolic compositions of the present invention that are used to make abrasive articles (e.g., sandpaper, emery cloth, surface conditioning disks, cutting wheels, grinding wheels, honing stones, mounted points, saw blades, and the like). The abrasive articles using the phenolic composition of the present invention can be of any type, that is, the composition of the present invention can be used for coated abrasives, non-woven abrasives, and bonded abrasives. The phenolic composition of the present invention when used as a coating (e.g., as a photomask, a varnish, and the like).

### EXAMPLE 1

### Phenolic Expansible Clay Adhesion To Glass

Cloisite® Na obtained from Southern Clay Products, Inc. was mixed with demineralized water to obtain a 0.76% dispersion by weight. To 100 parts Resole 1 (a nominally 65% solids content, thermosetting phenol-formaldehyde resin in water) was added 100 parts by weight 0.76% Cloisite® Na dispersion, sample 1EC. A control resole was made by adding 100 parts by weight demineralized water to 100 parts Resole 1. About 30 grams of each shaken mixture were decanted into separate 1 quart Glass cookware bowls. The sample bowls were placed into a convection oven and heated for 90 minutes at 80°-90° C and then at about 120° C. for 2 hours. After cooling the following was observed.

The control cured phenolic resin (Sample 1C) dislodged readily in one piece, molded in the shape of the glass cookware bottom, leaving essentially no residue behind. The 1.2% phenolic expansible clay composition Sample 1EC adhered strongly to the cookware bottom and could not be removed from the glass bowl. Some pieces of phenolic expansible clay 1EC were chiseled from the bottom of the bowl for microscopic examination.

The phenolic resins (1C and 1EC) were viewed under a 40 power magnification microscope with transmitted light. The control, 1C, was clear with some small bubbles present. The phenolic expansible clay, 1EC, was also clear. There were no visible clay particles in the phenolic expansible clay 1EC.

EXAMPLE 1 TABLE

Sample

| | | Phenolic Expansible |
|---|---|---|
| | Phenolic 1C | Clay 1EC |
| Adhesion to Glass | Negligible | Very, very high |
| Clarity | Clear | Clear |

### EXAMPLE 2

### Clay Paste Phenolic Expansible Clay Preparation and Glass Adhesion Test

A Closite® Na paste was prepared by adding 10.2 grams of water to 1.10 grams of Closite® Na. A low viscosity slurry formed upon initial mixing. After about ten minutes the slurry became a thick, uniform homogeneous Closite® Na paste.

Closite® Na paste (2.76 grams) was added to 16.30 grams of Resole 1 (about 2.5% clay). The paste was dispersed with mixing. After about 20 minutes most of the paste appeared to have dissolved and was no longer visible. After 6 hours the mixture was poured into one quart glass bowl and cured (1 hour at 90° C. followed by 2 hours at 125° C.) along with a separate control sample (23% water/77% Resole 1) in its own quart glass bowl.

The resulting cured phenolic expansible clay composition 2EC made with the Closite® Na paste adhered strongly to the glass cookware, although not as strongly as phenolic expansible clay 1EC in Example 1, and could not be removed whereas the control phenolic resin, 2C popped out of the cookware bottom cleanly leaving very little residue adhered to the glass surface.

### EXAMPLE 3

### Phenolic Expansible Clay Adhesion To Plywood

Phenolic Expansible Clay samples were made by dispersing different expansible clay samples (all obtained from Southern Clay Products) into Resole 2 (a nominally 80% solids content, 6000 cps, thermosetting phenol-formaldehyde resin in water) and allowing at least 24 hours at room temperature for the clay to disperse.

Phenolic Expansible Clay 3EC1 was made by dispersing 1.0 grams of Cloisite® Na into 51.1 grams of Resole 2. Phenolic Expansible Clay 3EC2 was prepared from 1.0 grams of Bentolite L-10 dispersed into 50.2 grams of Resole 2. Phenolic Expansible Clay 3EC3 was prepared from 0.93 grams of Laponite JS mixed into 47.3 grams of Resole 2. Finally, Phenolic Expansible Clay 3EC4 was produced from 1.69 grams of 40% organoclay, Cloisite® 15A added to 50.5 grams of Resole 2 to produce a similar clay solids content as the other Phenolic Expansible Clay samples. All Phenolic Expansible Clay samples except Phenolic Expansible Clay 3EC4 produced uniform, transparent-to-clear dispersions. In contrast, Phenolic Expansible Clay 3EC4 had a white, creamy layer on top of a turbid underlying layer. Phenolic Expansible Clay 3EC4 was vigorously stirred before applying it to the lap joint area.

A standard ⅝″ thick sheet of plywood obtained from The Home Depot was cut into pieces measuring about 3.5 inches in length by about 1 inch wide (and ⅝″ thick). Each test consisted of making two lap joints connecting three bars in a linear array. The two outside bars were on the bottom, 1.5 inches apart and the top bar joining them, placed on top in pyramid fashion. The top bar overlapped each bottom bar on a 1 inch by 1 inch surface. In each test one overlap surface was brush coated with a control resole whilst the second overlap surface was coated with the Phenolic Expansible Clay before placing the third piece in place on top. Viewed from above the assembly was 8.5 inches long by 1 inch wide.

Each assembly was constructed on a flat piece of sheet steel and placed into an oven for curing (nominally 1 hour at 90° C. followed by 2 hours at 125° C.).

In every test the control lap joint fell apart as soon as the cured assembly was even slightly disturbed. All cured phenolic expansible clay joints had greater integrity and withstood, to varying degrees, repeated tapping of one end on a 45 degree angle against a table when help by hand on the opposite end of the cured assembly.

The joint integrity was rated on a scale of 0 to 3. The 0 rating means the joint fell apart before the assembly could be picked up after curing. A rating of 1 means the assembly fell apart after being picked up. A rating of 2 was given for assemblies that could withstand several light taps on a table. The 3 rating was given for assemblies that were repeatedly tapped with more vigor without coming apart.

EXAMPLE 3 TABLE

| | | | | Phenolic |
|---|---|---|---|---|
| | | | Phenolic | Expansible |
| Test | Control | Control Lap | Expansible | Clay Lap |
| Assembly | Phenolic | Joint Rating | Clay | Joint Rating |
| A | 3C | 0 | 3EC1 | 3 |
| B | 3C | 0 | 3EC1 | 3 |
| C | 3C | 0 | 3EC3 | 1 |
| D | 3C | 0 | 3EC3 | 2 |
| E | 3C | 0 | 3EC2 | 2 |
| F | 3C | 0 | 3EC2 | 3 |
| G | 3C | 0 | 3EC4 | 1 |

### EXAMPLE 4

### 2% Phenolic Expansible Clay Abrasive

Resole 1 (50 grams, 65% solids) was mixed with 26 grams of 2.5% Coisite® Na water dispersion to make Phenolic Expansible Clay Resole 4EC containing 2% clay. The control resole (Resole 4C) was made by adding 26 grams of water to 50 grams of Resole 1.

Coated abrasive sheets were prepared for testing by the following procedure. A filled nylon sheet (50% 80 grit aluminum oxide in nylon 66 about 5 inches wide by 20 feet long and 0.050″ thick was obtained from Specialty Filaments, Inc. (now Thomas Monahan Company in Middlebury, Vt.). Two pieces of nylon sheet measuring 5 inches by 10 inches were weighed and placed into holders. Each sheet holder was a frame to hold the sheet flat during the coating and curing process. The holders have a flat stainless steel base measuring 6 inches by 10 inches. Two 0.25 inch thick aluminum bars measuring 1 inch by 10 inches were through bolted to the outside 10 inch edges of each base. The outside half inch of the nylon sheet was sandwiched between the aluminum bars and the stainless steel base and secured by tightening the through bolts. This presented an open area for coating each nylon sheet measuring approximately 4 inches by ten inches.

The sheets were then flame treated to enhance wetting using a conventional propane torch obtainable at any hardware store. The flame was adjusted to have a large amount of air which produced a darker blue inner flame and lighter orange outer flame. The exposed nylon sheet surface was passed approximately in contact with the tip of the inner blue flame at a rate of about 6 linear inches per second until the entire surface to be coated had been exposed to flame. Proper flame treatment reduced the sheet surface tension such that a droplet of water would spread into a thin film over a wide area instead of beading up in thick droplets.

The sheets were then coated as uniformly as possible by brush with the phenolic expansible clay resole or the control resole. The weight of uncured coating was recorded in Table 4 as the Base Coat Weight.

Immediately after weighing the coated samples, silanated 80 grit aluminum oxide (80 AL2O3) (obtained from AGSCO Corporation) was uniformly sprinkled onto the coated sheets to saturate the coated surface. The Al2O3 coated sheet holder assembly was then tapped on edge vertically several times to remove any loose Al2O3. The weight of Al2O3 adhering to each sheet was then obtained (Abrasive Weight in Table 4).

The Base Coat was then cured at 90° C. for about 30 minutes followed by one hour at 125° C.

Next, a topcoat was added (Topcoat Type, Topcoat Weight) and then cured (30 minutes at 90° C. followed by 2 hours at 120° C.-130° C. The final cured phenolic plus abrasive particles coating weight (Total Cured Coating Weight) was then determined. Both sheets were cured, side by side, simultaneously in the same oven to ensure similar heat history.

EXAMPLE 4 TABLE

Sample

| | Phenolic Abrasive | Phenolic Expansible |
|---|---|---|
| | 4C | Clay Abrasive 4EC |
| Sheet Type | 0.045 inch nylon | 0.045 inch nylon |
| Base Coat | Resole 4C | Phenolic Expansible |
| | | Clay Resole 4EC |
| Base Coat Weight | 4.1 g | 4.1 g |
| (grams) | | |
| Abrasive Particles | 80 Al2O3 | 80 Al2O3 |
| Abrasive Weight | 8.2 g | 7.9 g |
| (grams) | | |
| Topcoat Type | Resole 4C | Phenolic Expansible |
| | | Clay Resole 4EC |
| Total Cured Coating | 11.4 g | 11.4 g |
| Weight (grams) | | |
| Grams 304 SS Cut | 0.17 g | 0.21 g |
| Disk 1 | | |
| Grams 304 SS Cut | 0.18 g | 0.21 g |
| Disk 2 | | |
| Grams 304 SS Cut | 0.18 g | 0.32 g |
| Disk 3 | | |
| Grams 304 SS Cut | 0.18 g | 0.28 g |
| Disk 4 | | |
| Grams 304 SS Cut | 0.17 g | 0.24 g |
| Disk 5 | | |
| Grams 304 SS Cut | 0.19 g | 0.28 g |
| Disk 6 | | |
| Average of 6 tests | 0.18 g | 0.26 g |

The coated abrasive sheets were removed from their holders and 6 one inch diameter disks of each were punched from each sheet using a metal punch and hammer. A center hole was drilled through each disk with a 1/16 inch drill bit. The disks were attached for testing to a Bosch Dremel® tool using a standard, Dremel® 1 inch cut off blade mandrel adapter.

The testing consisted of cutting the 90 degree edges of a 304 stainless steel bar end (1 inch by 4 inch bar measuring 0.25 inches thick) with the disk surface while being rotated at high speed (number 8 setting of 10) with the Dremel®. The test was continued until the disk was worn out and would remove no more metal. The total weight of stainless steel that each disk removed from each bar was then measured and recorded. The average amount of stainless steel removed by Phenolic expansible clay Abrasive 4EC disks was 0.26 grams compared with 0.18 grams on average removed by the control Phenolic Abrasive Disks 4C. Thus, the Phenolic expansible clay Abrasive disks surprisingly cut 44% more stainless steel than the control Phenolic Abrasive Disks.

### EXAMPLE 5

### 2.9% Phenolic Expansible Clay Abrasive

Resole 1 (50 grams, 65% solids) was mixed with 39 grams of 2.5% Cloisite® Na water dispersion to make Resole 5EC (2.9% clay). The control resole (Resole 5C) was made by adding 39 grams of water to 50 grams of Resole 1.

Abrasive sheets were prepared by the same procedure as in Example 4 except that 2 topcoats were used (total of 3 cure cycles, one for the base and one each after each topcoat). The second topcoat was added in order to have the base of the abrasive particles about 65% covered (or anchored) in the phenolic layer (because of the high dilution and lower viscosity, two topcoats were needed to achieve this coating depth).

Similar testing was done as in Example 4 on the stainless steel bar edges except in this example the bars were ground for a measured time interval and then weighed. The grinding and weighing cycles were repeated several cycles until the rate of steel removed during that cycle decreased dramatically, thereby indicating the abrasive disk was losing its cutting ability. The results are listed in Example 5 Table.

The test disks were visually examined with a 40 power microscope during and after the testing. The phenolic abrasive layer for control Phenolic Abrasive 5C fractured to a much greater extent than that of Phenolic Expansible Clay Abrasive 5EC indicating that Phenolic Expansible Clay Abrasive 5EC is substantially tougher than control Phenolic Abrasive 5C. It was also apparent that Phenolic Expansible Clay Abrasive 5EC held more abrasive particles in place during the testing and also adhered better to the nylon sheet.

EXAMPLE 5 TABLE

Sample

| | Phenolic Expansible | Control Phenolic |
|---|---|---|
| | Clay Abrasive 5EC | Abrasive 5C |
| | Cumulative 304 | Cumulative 304 |
| Cumulative Cutting | Stainless Steel | Stainless Steel |
| Time (minutes) | Removed (grams) | Removed (grams) |
| 0 | 0 | 0 |
| 5 | 0.32 | 0.34 |
| 8 | 0.44 | 0.39 |
| 11 | 0.54 | 0.44 |
| 14 | 0.61 | 0.45 |
| Relative Cut Versus | 1.4 | 1.0 |
| Control | | |

### EXAMPLE 6

### 2.5% Direct Phenolic Expansible Clay Resole Preparation and Phenolic Expansible Clay Abrasive Made Therefrom

To 25 grams of Resole 1 (65% solids) was added 0.41 g of Closite® Na. After 15 minutes the Closite® Na appeared to have dissolved and the mixture was slightly cloudy. After 4 hours the mixture was completely clear.

Abrasive sheets were prepared as in Example 4. Only one top coat was needed. The abrasive particles protruded from the top of the phenolic coating layers for both the cured Phenolic Expansible Clay Abrasive 6EC as well as the control Phenolic Abrasive 6C (this represents a similar Coated Abrasive type of morphology as obtained in examples 4 and 5).

Testing was conducted as in Example 5. The Phenolic expansible clay Abrasive 6EC greatly outperformed the Control Phenolic Abrasive 6C. Results are shown in Example 6 Table.

EXAMPLE 6 TABLE

Sample

| | Phenolic Expansible | Control Phenolic |
|---|---|---|
| | Clay Abrasive 6EC | Abrasive 6C |
| | Cumulative 304 | Cumulative 304 |
| Cumulative Cutting | Stainless Steel | Stainless Steel |
| Time (minutes) | Removed (grams) | Removed (grams) |
| 0 | 0 | 0 |
| 3 | 0.20 | 0.10 |
| 6 | 0.38 | 0.26 |
| 9 | 0.58 | 0.34 |
| 12 | 0.71 | 0.44 |
| 15 | 0.82 | 0.51 |
| Relative Cut Versus | 1.6 | 1.0 |
| Control | | |

### EXAMPLE 7

### 2.4% Phenolic Expansible Clay Bonded Abrasive

A Phenolic Expansible Clay Resole 7EC was prepared by adding 0.54 grams of Closite® Na to 27.23 grams of Resole 2 (nominally 80% solids). A control resole 7C was also prepared by measuring 27.2 grams of Resole 2 into a similar container. After 17 hours there were no particles visible (40× magnification) in the resulting Phenolic Expansible Clay Resole dispersion 7EC, however it was slightly cloudy. The control resole, 7C was clear.

Abrasives were prepared as in example 4; however a thin (0.015 inch) fabric backing was used as the base. The resulting cured abrasive disks had the abrasive particles completely buried in the phenolic layer due to the high viscosity of the high solids resole used in this test. This morphology can be referred to as a Bonded abrasive morphology (similar to a grinding wheel type of structure) since the abrasive particles are contained within the bonding (phenolic) layer. Abrasives of Examples 4, 5, 6 all had a Coated Abrasive morphology where a substantial portion of the abrasive particles protrude above the surface of the cured bonding (phenolic) layer (similar to sand paper or a non-woven abrasive such as a Merit® Surface Conditioning disk).

Again 1 inch disks were punched from the cured abrasives. The uncoated bottoms of the abrasive disks were glued with epoxy (Masterweld 5977A and 977B) to 1 inch disks made from 0.050 inch thick nylon sheet (purchased from McMaster Carr) since the abrasive disks were too flexible to test due to the thinness of the fabric base. The glued disks were then heated for 90 minutes at 90° C.-120° C. to fully cure the epoxy.

The disks were tested for six minutes on the edge of stainless steel in similar fashion as described in Example 2. The Phenolic Expansible Clay abrasive 7EC cut about 50% more stainless steel than the control abrasive, 7C. There were startling differences in the after test appearance of the Phenolic Expansible Clay abrasive disc in comparison to the control abrasive disk.

The control disk had its phenolic abrasive layer extensively delaminated from the backing and jagged chunks of the phenolic abrasive layer were missing due to brittle failure of the phenolic abrasive coating. The parts remaining of control phenolic abrasive layer on the disk were extensively fractured and most of the abrasive particles appeared to have been ejected from the layer leaving holes behind.

The Phenolic Expansible Clay abrasive, 7EC layer was still nicely circular with a mostly even wear pattern around the periphery of the disk. Some cracks were visible in the used Phenolic Expansible Clay abrasive disk 7EC; however the particles were essentially all intact. In fact the tops of the particles were ground away with some of the phenolic layer itself.

This showed the Bonded type Phenolic Expansible Clay abrasive 7EC cut more, was tougher, was more damage resistant and adhered to the abrasive particles and backing more effectively than the control Bonded abrasive 7C.

### EXAMPLE 8

### Phenolic Expansible Clay Content Affect on Abrasive Work

Phenolic Expansible Clay samples at various clay concentrations were prepared by the following procedure. Resole 3 (a nominally 80% solids, 5000 cps, thermosetting, phenol-formaldehyde resin in water) was diluted to 65% solids in water. The clay was then added at various percentages. The mixtures were stirred to effectively disperse and wet the clay and allowed to sit at room temperature for about 24 hours. Next coated abrasive samples were prepared as in Example 4 above using the same sheet and 80 grit Aluminum Oxide. The same control resole or Phenolic Expansible Clay Resole was used for both the base and top coats.

Sets of up to four samples were prepared and cured, simultaneously. This was done to ensure similar heat history for each sample in a set. The results are listed in the Example 8 Comparative Set tables below. One inch test disks were then cut and tested as described in Example 4 with a Dremel tool. Four 3 minute cycles of testing with the Dremel® set on speed 9 were done. The weight of stainless steel removed after each 3 minute cycle was measured and recorded. All disks were worn out after 12 minutes of cutting. The cut results are tabulated below as cumulative total cut.

EXAMPLE 8 COMPARATIVE SET 1 TABLE

Sample

| | 8-1-0 | 8-1.23 | 8-2.44 | 8-3.6 |
|---|---|---|---|---|
| % Expansible | 0 (Set 1 | 1.23% | 2.44% | 3.6% |
| Clay | control) | | | |
| Base Coat | 4.0 | 4.1 | 4.1 | 4.1 |
| Weight | | | | |
| (grams) | | | | |
| Top Coat | 4.2 | 4.1 | 4.2 | 4.2 |
| Weight | | | | |
| (grams) | | | | |
| 304 SS Cut | | | | |
| (grams) | | | | |
| 3 min | 0.3 | 0.35 | 0.44 | 0.42 |
| 6 min | 0.71 | 0.64 | 0.77 | 0.74 |
| 9 min | 0.93 | 1.15 | 1.13 | 0.85 |
| 12 min | 0.97 | 1.48 | 1.31 | 0.9 |
| Total Work | 1.0 | 1.52 | 1.35 | 0.93 |
| versus | | | | |
| Control | | | | |

| | EXAMPLE 8 COMPARATIVE SET 2 TABLE | | |
|---|---|---|---|
| | Sample | | |
| | 8-5.0 | 8-25.0 | 8-2-0 |
| % Expansible | 5.0% | 25% | 0 Set 2 Control |
| Clay | | | |
| Base Coat | 4.3 | 4.2 | 4.1 |
| Weight | | | |
| (grams) | | | |
| Top Coat | 3.3 | 4.2 | 4.0 |
| Weight | | | |
| (grams) | | | |
| 304 SS Cut | | | |
| (grams) | | | |
| 3 min | 0.15 | 0.2 | 0.42 |
| 6 min | 0.25 | 0.33 | 0.74 |
| 9 min | 0.36 | 0.41 | 1.02 |
| 12 min | 0.48 | 0.48 | 1.18 |
| Total Work | 0.41 | 0.41 | 1.0 |
| versus Control | | | |

| | EXAMPLE 8 COMPARATIVE SET 3 TABLE | | |
|---|---|---|---|
| | Sample | | |
| | 8-3-0 | 8-0.74 | 8-1.72 |
| % Expansible | 0 (Set 3 | 0.74% | 1.72% |
| Clay | control) | | |
| Base Coat | 3.4 | 3.6 | 3.8 |
| Weight | | | |
| (grams) | | | |
| Top Coat | 3.0 | 3.0 | 3.6 |
| Weight | | | |
| (grams) | | | |
| 304 SS Cut | | | |
| (grams) | | | |
| 3 min | 0.31 | 0.28, 0.28 | 0.27 |
| 6 min | 0.57 | 0.62, 0.67 | 0.60 |
| 9 min | 0.74 | 0.85, 0.85 | 0.95 |
| 12 min | 0.85 | 0.89, 0.88 | 1.43 |
| Total Work | 1.0 | 1.05, 1.04 | 1.68 |
| versus Control | | | |

Table “Example 8 Summary Table Closite® Na vs. Total Work” summarizes results of expansible clay content versus total work. It shows a surprising non-linear, positive impact of expansible clay content on the abrasive work for concentrations between about 0.5% and 4% expansible clay, with an optimal concentration of about 1.7% for this resole composition.

EXAMPLE 8 SUMMARY TABLE
Closite ® Na vs. Total Work

| | Total Work (Normalized To |
|---|---|
| Cloisite ® Na Content | Control) |
| 0% (Control) | 1.0 |
| 0.74% | 1.1 |
| 1.23% | 1.5 |
| 1.72% | 1.7 |
| 2.44% | 1.4 |
| 3.6% | 0.9 |
| 5.0% | 0.4 |
| 25% | 0.4 |

### EXAMPLE 9

### Phenolic Expansible Organoclay Abrasive versus Control Abrasive Work

A Phenolic Expansible Organoclay abrasive and control were prepared as in Example 8. The organoclay was Cloisite® 15A containing 41% organo component and was obtained from Southern Clay. The amount of clay added was corrected for the organo content so that an accurate comparison could be made with the corresponding Phenolic Expansible Clay example. For example, a 2.44% Phenolic Expansible Clay would be prepared from 97.56 grams of resole solids plus 2.44 grams of expansible clay (Cloisite® Na+) but the 2.44% organo phenolic expansible clay would be made from 97.56 grams of resole solids plus 4.13 grams (2.44/0.59) of Cloisite® 15A containing 41% organo component.

EXAMPLE 9 TABLE

Sample

| | 9-0 | 9-Organo 2.44 |
|---|---|---|
| % Organoclay | 0 (control) | 4.06% |
| Base Coat | 3.5 | 3.3 |
| Weight | | |
| (grams) | | |
| 80 Al2O3 | 14.75 | 14.75 |
| Weight | | |
| (grams) | | |
| Top Coat | 4.1 | 4.3 |
| Weight | | |
| (grams) | | |
| 304 SS Cut | | |
| (grams) | | |
| 3 min | 0.33 | 0.44 |
| 6 min | 0.69 | 0.74 |
| 9 min | 1.04 | 0.89 |
| 12 min | 1.23 | 0.99 |
| Total Work | 1.0 | 0.80 |
| versus Control | | |

1. A phenolic resin composition containing less than 5 percent by weight of wholly inorganic expansible clay particles well dispersed therein.

2. The composition of claim 1 where the clay is sodium montmorillonite.

3. The composition of claim 1 where the clay is bentonite.

4. The composition of claim 1 where the clay is synthetic and is a hydrous sodium lithium magnesium silicate or a hydrous sodium lithium magnesium fluoro-silicate.

5. The composition of claim 1 where the clay is synthetic swelling mica.

6. The composition of claim 1 where the phenolic resin is a resole.

7. The composition of claim 1 where the phenolic resin is a novolak.

8. The composition of claim 1 which further comprises materials selected from the group consisting of additives, impact modifiers, fillers, and reinforcements.

9. A phenolic resin composition containing less than 5 percent by weight of a wholly inorganic expansible clay prepared by combining the phenolic resin components, the expansible clay, and additional water in an amount from 0.5 parts to 500 parts additional water per part of clay.

10. The composition of claim 9 where the phenolic resin components are monomers and the mixing occurs in the reactor prior to polymerization.

11. The composition of claim 9 where the phenolic resin components have been allowed to react to some degree prior to clay addition, and the mixing occurs in the polymerization reactor.

12. The composition of claim 9 where the phenolic resin has been discharged from the polymerization reactor, and the clay added to an aqueous phenolic resin syrup or clay and water added to form the aqueous phenolic resin syrup.

13. The composition of claim 9 where the phenolic resin has been discharged from the polymerization reactor and is in solution with an organic solvent or mixed organic/water solvent when the clay and/or additional water are added.

14. A molding resin, and the cured, finished articles thereof comprising the composition of claim 1.

15. An adhesive compound used to join light fixture parts and the cured, finished articles thereof comprising the composition of claim 1.

16. A joining compound used to join abrasive particles into designed assemblies and the cured, finished articles thereof comprising the composition of claim 1.

17. A joining compound containing abrasives used to make coated, nonwoven or bonded abrasives and the cured, finished articles thereof comprising the composition of claim 1.

18. A joining compound used to join wood and the cured, finished articles thereof comprising the composition of claim 1.

19. A joining compound used to make friction transmission products and the cured, finished articles thereof comprising the composition of claim 1.

20. A sealing compound used as a coating and the cured, finished articles thereof comprising the composition of claim 1.

21. A composition of claim 1 containing less than-3.5 percent by weight of wholly inorganic expansible clay particles well dispersed therein.
